(19) United States
(12) Patent Application Publication
(10) Pub. No.: US 2014/0329976 A1
(43) Pub. Date: Nov. 6, 2014

(54) Treatment Of Filler With Silane

(71) Applicant: Dow Corning Corporation, MIDLAND, MI (US)

(72) Inventors: Michael Wolfgang Backer, Mainz (DE); Thomas Chaussee, Fontaines Saint Martin (FR); Olivier Debever, Lembeek (BE); Francois De Buyl, Hoeilaart (BE)

(21) Appl. No.: 14/362,675

(22) PCT Filed: Dec. 7, 2012
(86) PCT No.: PCT/EP2012/074733

§ 371 Date: Jun. 4, 2014

(30) Foreign Application Priority Data
Dec. 8, 2011 (GB) 1121127.3

(51) Int. Cl. C07F 7/18; C08G 77/38

(52) U.S. Cl. CPC C07F 7/1892; C08G 77/38
USPC 525/477; 548/955; 525/50

(57) ABSTRACT

This invention relates to the treatment of a carbon based filler with a hydrolysable silane to modify the surface of the filler. It also relates to a carbon based filler modified by treatment with a hydrolysable silane, and to polymer compositions containing such a modified carbon based filler.

This invention relates to the treatment of a carbon based filler with a hydrolysable silane to modify the surface of the filler. It also relates to a carbon based filler modified by treatment with a hydrolysable silane, and to polymer compositions containing such a modified carbon based filler.

Examples of carbon based fillers include carbon black, which is used as a reinforcing filler in many polymer and rubber compositions, and carbon fibre, which is also used in reinforcing polymer compositions, particularly to give directional reinforcement. Further carbon based fillers include carbon nanotubes, graphene, expandable graphene and expandable graphite. Carbon based fillers generally bond well to organic polymers, particularly hydrocarbon polymers, to give reinforcement, but bond less well to more polar polymers. Carbon based fillers like carbon fibres can be used for example to replace heavier glass fibres providing same strength enhancement at a lighter weight.

The papers ‘Molecular recognition by a silica-bound fullerene derivative’ by A. Bianco et al in J. Am. Chem. Soc 1997, volume 119, at pages 7550-7554 and Tetrahedron, Vol. 57(32), 2001, pages 6997-7002 describe the reaction of N-[3-(triethoxysilyl)propyl]-2-carbomethoxyaziridine with fullerene. The hydrolysis rate of functionalized fullerenes bearing alkoxysilanes is described in Eur. J. Org. Chem. 2006, pages 2934-2941.

EP194161 describes the hydrolytic condensation of 3-(diethoxymethylsilyl)-propylamine and N-(3-diethoxymethyl silyl)propyl 2-carboethoxy aziridine.

A process according to the invention for modifying the surface of a carbon based filler by treatment with a hydrolysable silane is characterised in that the hydrolysable silane is a silane of the formula G-OC(O)-(Az)-J wherein G and J each represent a hydrocarbyl or substituted hydrocarbyl group having 1 to 40 carbon atoms, at least one of G and J being a group of the formula RₐR″₃₋ₐSi-A in which R represents a hydrolysable group; R″ represents a hydrocarbyl group having 1 to 8 carbon atoms; a has a value in the range 1 to 3 inclusive; Az represents an aziridine ring bonded to the group J through its nitrogen atom; and A represents a divalent organic spacer linkage having at least one carbon atom.

The invention includes a carbon based filler modified by treatment with a hydrolysable silane of the formula G-OC(O)-(Az)-J as defined above.

The invention also includes the use of a hydrolysable silane of the formula G-OC(O)-(Az)-J as defined above to modify the surface of a carbon based filler to introduce a reactive function on the surface of the filler.

The hydrolysable silanes of the formula G-OC(O)-(Az)-J as defined above are capable of bonding strongly to materials containing carbon-to-carbon unsaturation. Carbon based fillers such as carbon fibre, carbon black, carbon nanotubes, graphene, expandable graphene and expandable graphite generally contain some carbon-to-carbon unsaturation. The hydrolysable silanes of the formula G-OC(O)-(Az)-J as defined above bond to such carbon based fillers, for example under the processing conditions used for producing filled polymer compositions. We believe that upon heating to the temperatures used in polymer compounding, the aziridine ring of the hydrolysable silane reacts with the C═C bonds of the carbon based filler through cycloaddition. The hydrolysable silanes of the formula G-OC(O)-(Az)-J are also capable of bonding strongly through hydrolysis of the silane group to siloxane polymers, polymers containing alkoxysilane groups and polymers containing hydroxyl groups, thus forming effective coupling agents for carbon based fillers in such polymers.

Hydrolysable silanes in which n=3 may be preferred as having the maximum number of hydrolysable groups. Examples of groups of the formula RₐR′₃₋ₐSi-A- in which a=3 include trialkoxysilylalkyl groups such as triethoxysilylalkyl or trimethoxysilylalkyl groups, or triacetoxysilylalkyl groups. However hydrolysable silanes in which a=2 or a=1 are also useful coupling agents. In such hydrolysable silanes the group R′ is a hydrocarbyl group having 1 to 8 carbon atoms. Preferred groups R′ include alkyl groups having 1 to 4 carbon atoms such as methyl or ethyl, but R′ can be an alkyl group having more carbon atoms such as hexyl or 2-ethylhexyl or can be an aryl group such as phenyl. Examples of groups of the formula RₐR′₃₋ₐSi-A- in which a=2 include diethoxymethylsilylalkyl, diethoxyethylsilylalkyl, dimethoxymethylsilylalkyl or diacetoxymethylsilylalkyl groups.

Hydrolysable silanes in which the group R is an ethoxy group are often preferred. The alcohol or acid RH may be released when the silane is hydrolysed, and ethanol is the most environmentally friendly compound among the alcohols and acids.

In the group of the formula -A-SiRₐR″₃₋ₐ, A represents a divalent organic spacer linkage having 1 to 20 carbon atoms. Preferably A has 2 to 20 carbon atoms. A can conveniently be an alkylene group, particularly an alkylene group having 2 to 6 carbon atoms. Preferred examples of linkage A are —(CH₂)₃—, —(CH₂)₄—, and —CH₂CH(CH₃)CH₂-groups. The group of the formula RₐR′₃₋ₐSi-A can for example be a 3-(triethoxysilyl)propyl, 4-(triethoxysilyl)butyl, 2-methyl-3-(triethoxysilyl)propyl, 3-(trimethoxysilyl)propyl, 3-triacetoxysilylpropyl, 3-(diethoxymethylsilyl)propyl, 3-(diethoxyethylsilyl)propyl or 3-(diacetoxymethylsilyl)propyl group.

In the hydrolysable silanes of the formula G-OC(O)-(Az)-J in which G is a group of the formula RₐR′₃₋ₐSi-A-, J can be any hydrocarbyl or substituted hydrocarbyl group having 1 to 40 carbon atoms. J can for example be an alkyl group having 1 to 6 carbon atoms such as methyl, ethyl, butyl or hexyl, or can be a longer chain alkyl group, or can be an aryl group having 6 to 10 carbon atoms such as phenyl or tolyl or an aralkyl group such as benzyl or 2-phenylpropyl. J can alternatively be a substituted hydrocarbyl group such as a hydroxyalkyl, aminoalkyl, or alkoxyalkyl group or a group of the formula RₐR′₃₋ₐSi-A-.

In the hydrolysable silanes of the formula G-OC(O)-(Az)-J in which J is a group of the formula RₐR′₃₋ₐSi-A-, G can in general be any hydrocarbyl or substituted hydrocarbyl group having 1 to 40 carbon atoms. Y can for example be an alkyl group having 1 to 10 or more carbon atoms, an aryl group having 6 to 10 carbon atoms, an aralkyl group or a substituted hydrocarbyl group.

Hydrolysable silanes of the formula G-OC(O)-(Az)-J in which both G and J are substituted hydrocarbyl groups of the formula RₐR′₃₋ₐSi-A- are one type of preferred examples of hydrolysable silanes for use in the invention. Examples of such hydrolysable silanes include

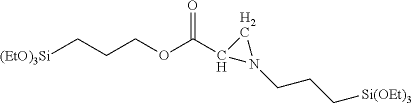

where Et represents ethyl and similar silanes in which one or both of the 3-(triethoxysilyl)propyl groups is replaced by a different RₐR′₃₋ₐSi-A- group selected from those listed above.

The hydrolysable silanes of the formula G-OC(O)-(Az)-J can in general be prepared by reacting an alkyl or substituted alkyl 2,3-dibromopropionate of the formula G—OC(O)—CHBr—CH₂Br with an amine of the formula J-NH₂, wherein G and J each represent a hydrocarbyl or substituted hydrocarbyl group having 1 to 40 carbon atoms, at least one of G and J being a group of the formula RₐR″₃₋ₐSi-A in which R represents a hydrolysable group; R″ represents a hydrocarbyl group having 1 to 8 carbon atoms; a has a value in the range 1 to 3 inclusive; and A represents a divalent organic spacer linkage having at least one carbon atom, (give reaction conditions.)

The 2,3-dibromopropionates of the formula G-OC(O)—CHBr—CH₂Br can be prepared from an acrylate of the formula G-OC(O)—CH═CH₂ by reaction with bromine at ambient temperature or below. For example the substituted alkyl 2,3-dibromopropionates of the formula Y—OC(O)—CHBr—CH₂Br in which Y is a group of the formula RₐR′₃₋ₐSi-A-, that is the substituted alkyl 2,3-dibromopropionates of the formula RₐR′₃₋ₐSi-A—OC(O)—CHBr—CH₂Br, where R, R′, a and A are defined as above, can be prepared by the reaction of an acrylate of the formula RₐR′₃₋ₐSi-A—OC(O)—CH═CH₂ with bromine.

The hydrolysable silanes of the formula G-OC(O)-(Az)-J in which J represents a group of the formula RₐR″₃₋ₐSi-A, where R, R′, a and A are defined as above, can be prepared by the reaction of a 2,3-dibromopropionate of the formula G-OC(O)—CHBr—CH₂Br with an amine of the formula RₐR′₃₋ₐSi-A—NH₂. The group G can for example be a substituted hydrocarbyl group which is the residue of a polyol having 2 to 6 alcohol groups. This 2,3-dibromopropionate can be prepared from the corresponding acrylate by reaction with bromine as described above. Examples of polyol acrylates that can be brominated and reacted with an alkoxysilylalkylamine include diacrylates such as ethyleneglycol diacrylate, di- and triethyleneglycol diacrylates and polyethyleneglycol diacrylates of varying chain lengths, propyleneglycol diacrylate, di- and tripropyleneglycol diacrylate and polypropyleneglycol diacrylates of varying chain lengths, butanediol-1,3- and -1,4-diacrylates, neopentylglycol diacrylate, hexanediol-1,6-diacrylate, isosorbide diacrylate, 1,4-cyclohexanedimethanol diacrylate, bisphenol-A-diacrylate and the diacrylates of bisphenol-A, hydroquinone, resorcinol lengthened with ethylene oxide and propylene oxide, triacrylates such as trimethylolpropane triacrylate, glycerol triacrylate, trimethylolethane triacrylate, 2-hydroxymethylbutanediol-1,4-triacrylate, and the triacrylates of glycerol, trimethylolethane or trimethylolpropane lengthened with ethylene oxide- or propylene oxide., and higher polyol acrylates such as pentaerythritol tetraacrylate and di-pentaerythritol hexaacrylate. Thus in a hydrolysable silane of the formula G-OC(O)-(Az)-J in which J represents a group of the formula RₐR″₃₋ₐSi-A, the group G may optionally represent a substituted hydrocarbyl group which is the residue of a polyol having 2 to 6 alcohol groups, the group G being bonded to 1 to 6 groups of the formula —OC(O)-(Az)-A′-Si—RₐR″₃₋ₐ

The hydrolysable silane of the formula G-OC(O)-(Az)-J as defined above can be partially hydrolysed and condensed into oligomers containing siloxane linkages. It is preferred that such oligomers still contain at least one hydrolysable group bonded to Si per silicon atom to enhance coupling of the carbon based filler with siloxane polymers and hydroxy-functional polymers.

The carbon based filler which is treated with the hydrolysable silane of the formula G-OC(O)-(Az)-J as defined above can for example be carbon fibre, carbon black, carbon nanotubes, graphene, expandable graphene and expandable graphite.

The hydrolysable silane is generally contacted with the carbon based filler when in a liquid form. The carbon based filler is preferably treated with the hydrolysable silane at a temperature in the range 110° C. to 190° C. Most of the hydrolysable silanes of the formula G-OC(O)-(Az)-J as defined above are liquid at the preferred temperature of treatment. These liquid hydrolysable silanes can be applied undiluted or in the form of a solution or emulsion. A hydrolysable silane which is solid at the temperature of treatment is applied in the form of a solution or emulsion.

Thus in one process according to the invention the polymeric material, the carbon-based filler and the hydrolysable silane are heated together preferably at a temperature of 120 to 200° C., whereby the polymeric material is crosslinked by the hydrolysable silane. Such in-situ process permits to form in one step the composite material containing the modified filler and the polymer matrix.

Various types of equipment can be used to treat the carbon based filler with the hydrolysable silane. Suitable types will depend on the form of the carbon based filler. For a particulate filler such as carbon black, a mixer can be used such as a Banbury mixer, a Brabender Plastograph (Trade Mark) 350S mixer, a pin mixer, a paddle mixer such as a twin counter-rotating paddle mixer, a Glatt granulator, a Lödige equipment for filler treatment, a ploughshare mixer or an intensive mixer including a high shear mixing arm within a rotating cylindrical vessel. A fibrous filler such as carbon fibre can be treated in tow, yarn, tyre cord, cut fibre or fabric form using an appropriate process known in the textile industry, for example a tow, yarn or fabric can be treated by spraying, gravure coating, bar coating, roller coating such as lick roller, 2-roll mill, dip coating or knife-over-roller coating, knife-over-air coating, padding or screen-printing.

The carbon based filler modified by treatment with the hydrolysable silane can be used in various polymer compositions. For example a filled polymer composition comprising an organosilicon polymer and the modified carbon based filler has the advantage that the hydrolysable silane acts as a compatibilising agent between the filler and the organosilicon polymer matrix. The organosilicon polymer can be an organopolysiloxane such as a polydiorganosiloxane. Polydiorganosiloxanes, such as polydimethylsiloxane, often have a terminal Si-bonded OH group or Si-bonded alkoxy group, and the hydrolysable silane of the invention bonds particularly strongly to such organosilicon polymers. The hydrolysable silane thus acts as a coupling agent for the carbon based filler and the organosilicon polymer, forming filled polymer compositions of improved physical properties. Examples of the physical properties that can be improved include thermal conductivity & thus heat dissipation, flame retardancy, mechanical properties such as tensile strength obtained by reinforcement, reduction of crack failure at the polymer/filler interface, electrical conductivity and thermal stability. For example the improved electrical conductivity is of advantage in polymer compositions used in electronic devices and solar cells.

Similar advantages are obtained when the carbon based filler modified by treatment with the hydrolysable silane is incorporated in polymer compositions comprising a polymer grafted with an alkoxysilane, for example polyethylene grafted with a vinylalkoxysilane or polypropylene grafted with an acryloxysilane or sorbyloxysilane or polyamide. An example of an application in which the improved thermal stability is of great advantage is in the production of hoses from grafted polypropylene, where a higher heat deflection temperature is achieved. Polymer compositions modified by silanes are for example described in WO2010/000477, WO2010/000478 and WO2010/000479.

Similar advantages are obtained when the carbon based filler modified by treatment with the hydrolysable silane is incorporated in rubber compositions modified by a silane for example SBR (styrene butadiene rubber), BR (polybutadiene rubber), NR (natural rubber), IIR (butyl rubber). Rubbers modified by silanes are described for example in WO2010/125124 and WO2010125123.

Another type of polymer composition in which the carbon based filler modified by treatment with the hydrolysable silane can be used is a composition comprising an organic polymer and a crosslinking agent containing organosilicon groups. An example of such a composition is an epoxy resin composition containing an amino-functional alkoxysilane crosslinking agent. The hydrolysable silane thus acts as a coupling agent between the carbon based filler and the amino-functional alkoxysilane, and as the amino-functional alkoxysilane crosslinks the epoxy resin the hydrolysable silane thus acts as a coupling agent between the carbon based filler and the epoxy resin matrix, forming filled epoxy compositions of improved physical properties.

The carbon based filler modified by treatment with the hydrolysable silane can be used in various polymer compositions. This filler treatment creates a coupling agent between the filler and the polymer matrix containing a vinyl group. For example a filled polymer composition comprising a thermoplastic resin, a thermoset resin or an elastomer shows improved adhesion and/or coupling of the carbon based filler to the polymeric material if the carbon based filler is modified by treatment with the amine compound (I) or (II). This can ensure creation of an intimate network between the carbon based filler and the polymer matrix wherein the filler is dispersed. A better coupling between the filler and the polymer matrix gives better reinforcing properties and can also give better thermal and electrical conductivity.

Examples of thermoplastic resins include organic polymers such as hydrocarbon polymers like for example polyethylene or polypropylene, fluorohydrocarbon polymers like Teflon, silane modified hydrocarbon polymers, maleic anhydride modified hydrocarbon polymers, vinyl polymers, acrylic polymers, polyesters, polyamides and polyurethanes.

When producing a filled thermoset resin composition, the modified carbon based filler is generally compounded with the thermosetting resin before the resin is cured. Examples of thermosetting resins include epoxy resins, polyurethanes, amino-formaldehyde resins and phenolic resins. Thermosetting resins may include aminosilane as curing agent.

The modified carbon filler can also be used in silicone polymers or in polymers containing silyl groups. For example it can be used in silicone elastomers, silicone rubbers, resins, sealants, adhesives, coatings, vinyl functionalised PDMS (with terminal or pendant Si-vinyl groups), silanol functional PDMS (with terminal and/or pendant silanol groups), and silyl-alkoxy functional PDMS (with terminal and/or pendant silyl groups). A wide range of applications of such silicone based materials exist for example in electronics, for managing thermal and electrical properties like for example conductivity. It can further be used in silicone-organic copolymers like for example silicone polyethers or in silyl-modified organic polymers with terminated or pendant silyl group. This includes any type of silyl terminated polymers like polyether, polyurethane, acrylate, polyisobutylene, grafted polyolefin etc. For example a silicone elastomer can contain modified carbon nanotubes to form a composite coating on metal having improved thermal properties.

The modified carbon based filler can be dispersed in an elastomer like a diene elastomer i.e. a polymer having elastic properties at room temperature, mixing temperature or at the usage temperature, which can be polymerized from a diene monomer. Typically, a diene elastomer is a polymer containing at least one ene (carbon-carbon double bond, C═C) having a hydrogen atom on the alpha carbon next to the C═C bond. The diene elastomer can be a natural polymer such as natural rubber or can be a synthetic polymer derived at least in part from a diene. The diene elastomer can for example be:
(a) any homopolymer obtained by polymerization of a conjugated diene monomer having 4 to 12 carbon atoms;
(b) any copolymer obtained by copolymerization of one or more dienes conjugated together or with one or more vinyl aromatic compounds having 8 to 20 carbon atoms;
(c) a ternary copolymer obtained by copolymerization of ethylene, of an [alpha]-olefin having 3 to 6 carbon atoms with a non-conjugated diene monomer having 6 to 12 carbon atoms, such as, for example, the elastomers obtained from ethylene, from propylene with a non-conjugated diene monomer of the aforementioned type, such as in particular 1,4-hexadiene, ethylidene norbornene or dicyclopentadiene;
(d) a copolymer of isobutene and isoprene (butyl rubber), and also the halogenated, in particular chlorinated or brominated, versions of this type of copolymer.

Suitable conjugated dienes are, in particular, 1,3-butadiene, 2-methyl-1,3-butadiene, 2,3-di(C₁-C₅ alkyl)-1,3-butadienes such as, for instance, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene. Suitable vinyl-aromatic compounds are, for example, styrene, ortho-, meta- and para-methylstyrene, the commercial mixture “vinyltoluene”, para-tert.-butylstyrene, methoxystyrenes, chlorostyrenes, vinylmesitylene, divinylbenzene and vinylnaphthalene.

The carbon based fillers modified by treatment with the hydrolysable silane can also be used to achieve filled polymer compositions having equal physical properties at lighter weight. Carbon based fillers are generally 30% lighter than the silica fillers used in organosilicon polymer compositions, and graphene or carbon nanotubes also give the same reinforcement at lower volume fraction. Similarly carbon fibres modified by treatment with the hydrolysable silane can form lighter weight compositions having equal physical properties if replacing glass fibres.

The hydrolysable silane also improves the compatibility and adhesion between a carbon based filler such as carbon black and a glass fibre filler when carbon based filler modified by treatment with the hydrolysable silane and a glass fibre filler are used together in a filled polymer composition. The physical properties of the composition, for example a composition for forming wind turbine blades, are thereby improved.

The carbon based filler modified by treatment with the hydrolysable silane can be used in conjunction with other fillers in a filled polymer composition. Such other fillers can be any type of filler or fibre, synthetic or natural, and for example include glass fibres, wood fibres or silica, or bio-fillers like starch, cellulose including cellulose nanowhiskers, hemp, talc, polyester, polypropylene, polyamide etc. The mixture of fillers can be used in a thermoplastic resin, a thermoset resin or an elastomer as described above. A mixture of carbon based filler modified by treatment with hydrolysable silane and a glass fibre filler can for example be used in a filled polymer composition for forming wind turbine blades.

The invention provides a process for modifying the surface of a carbon based filler by treatment with a hydrolysable silane, characterised in that the hydrolysable silane is a silane of the formula G-OC(O)-(Az)-J wherein G and J each represent a hydrocarbyl or substituted hydrocarbyl group having 1 to 40 carbon atoms, at least one of G and J being a group of the formula RₐR″₃₋ₐSi-A (herein called “silane group”) in which R represents a hydrolysable group; R″ represents a hydrocarbyl group having 1 to 8 carbon atoms; a has a value in the range 1 to 3 inclusive; Az represents an aziridine ring bonded to the group J through its nitrogen atom; and A represents a divalent organic spacer linkage having at least one carbon atom provided that when in J, A is a propyl group then G has at least 3 carbon atoms and preferably provided that when G is a silane group, J can either be a silane group, alkyl, aryl or substituted hydrocarbon group.

The invention provides a process characterised in that the hydrolysable silane has the formula RₐR″₃₋ₐSi-A—OC(O)-(Az)-J wherein R, R″, A, a and Az are defined as in Claim 1 and J represents a hydrocarbyl or substituted hydrocarbyl group having 1 to 40 carbon atoms.

The invention provides a process characterised in that the hydrolysable silane has the formula G—OC(O)-(Az)-A-Si—RₐR″₃₋ₐ wherein R, R″, A, a and Az are defined as in Claim 1 and G represents a hydrocarbyl or substituted hydrocarbyl group having a total of 3 to 40 carbon atoms.

The invention provides a process characterised in that the group G of the hydrolysable silane represents a substituted hydrocarbyl group which is the residue of a polyol having 2 to 6 alcohol groups, the group G being bonded to 1 to 6 groups of the formula —OC(O)-(Az)-A′-Si—RₐR″₃₋ₐ wherein R, R″, A, a and Az are defined as in Claim 1. Preferably, both J and G are silane groups.

The invention provides a process characterised in that each group R is an alkoxy group having 1 to 4 carbon atoms, preferably an ethoxy group.

Preferably, a=3.

Preferably, the carbon based filler comprises carbon fibres or is carbon black.

Preferably the carbon based filler is selected from carbon nanotubes, graphene and expandable graphene.

The invention further provides a carbon based filler modified by treatment with a hydrolysable silane as defined above.

The invention provides a filled polymer composition comprising an organosilicon polymer and a modified carbon based filler as defined above.

The invention provides a filled polymer composition comprising a an organic polymer, a crosslinking agent containing organosilicon groups and a modified carbon based filler as defined above.

The invention provides a filled polymer composition comprising a polymer matrix a modified carbon based filler as defined above, and any other type of filler or fibre.

The invention provides the Use of a hydrolysable of the formula G-OC(O)-(Az)-J wherein G and J each represent a hydrocarbyl or substituted hydrocarbyl group having 1 to 40 carbon atoms, at least one of G and J being a group of the formula RaR″3-aSi-A in which R represents a hydrolysable group; R″ represents a hydrocarbyl group having 1 to 8 carbon atoms; a has a value in the range 1 to 3 inclusive; Az represents an aziridine ring bonded to the group J through its nitrogen atom; and A represents a divalent organic spacer linkage having at least one carbon atom, to modify the surface of a carbon based filler to introduce a reactive function on the surface of the filler.

### EXAMPLES

### Silane Synthesis

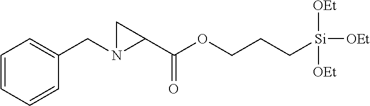 [SMILES: CCO[Si](CCCOC(=O)C1CN1Cc1ccccc1)(OCC)OCC]

Detailed description of the N-benzyl aziridine 2-(3-triethoxysilylpropyl)carboxylate. A 1 L two-necked round bottom flask, fitted with a condenser, nitrogen sweep and magnetic stirrer, was charged with 14.1 g benzylamine, 33.2 g triethylamine and 160 ml toluene and inserted with nitrogen. To this ice-cold mixture was added drop-wise a solution of 57.2 g (3-triethoxysilylpropyl)-2,3-dibromopropionate in 160 ml toluene. Mixture was refluxed for 6 hours and solids filtered off over diatomaceous earth. Solvent and volatiles was removed in vacuo affording the aziridine as a light orange liquid. Formation of the aziridine ring was confirmed by nuclear magnetic resonance spectroscopy.

### Examples 1 to 3

The following material were used:
Silane 1-3-(propyltriethoxysilyl)-N-benzyl aziridine carboxylate
CNT—Multiwall carbon nanotube from Nanocyl company—Nanocyl™ NC 7000
Molecule 1—Sarcosine from Sigma Aldrich
p-H2CO—para-formaldehyde from Sigma Aldrich

All examples were made using the following treatment procedure. To allow good deposition of silane and non silane molecule on the surface of the CNTs, a dispersion in ethanol was prepared—for 1 g of CNT 40 ml of absolute ethanol was used. After dispersion of CNT, silane and if necessary p-H2CO were added. The solution was stirred for 2 hours at room temperature. After stirring, Ethanol was removed using a rotavapor with a temperature of 50° C. under vacuum. Dried CNT with silane and when present p-H2CO deposit on the surface were heated up in a ventilated oven at 210° C. for time of 2 or 6 hours to optimize deposit on the CNT surface. Treated CNT were then washed using ethanol (70 ml of ethanol for 5 g of treated CNT) to wash out non reacted material. Washed and heat treated CNT were then dried using a rotavapor with a temperature of 50° C. under vacuum to remove traces of ethanol. The obtained samples were then analysed by TGA to detect residual material on the surface and to quantify grafted material.

### TGA Results:

Instrument: TGA851/SDTA (Mettler-Toledo), Alumina pan 150 ul, nitrogen & air flow (100 ml/min). See method on graphs. A background of an empty Alumina pan was recorded in the same conditions and subtracted to the TGA of each sample (baseline correction).

### TGA Procedure:

25° C. for 2 min under N2
Ramp from 25° C. to 650° C. 10° C./min under N2
Cooling to 550° C. under N2
2 min at 550° C. switch to air
Ramp to 1000° C. at 10° C./min under air

The quantification of the deposited product was based for silane on the residue at the end of the procedure. This residue corresponded to silica char formation by degradation of the silane in addition of residue from the carbon nanotubes. Corrected weight residue corresponded to the residue measured on the sample on which residue from pure CNT was substracted to quantify residue from silane only.

Mole of product was determined using the following equation: Product mol reacted on CNT surface for 100 g of analysed grafted CNT=corrected residue (%)/(60*Functionality)

Where 60 is the silica molecular weight and functionality is the number of Si atom for each silane molecule. Functionality was 1 for mono silane (silane 1 and 2), functionality is 2 for bis-silane (silane 3 and 4)

The quantification of the deposited product was based on weight loss between 150° C. to 650° C. pure CNT weight loss was substracted to quantify residue from treating agent only.

Mole of product was determined using the following equation: Product mol reacted on CNT surface for 100 g of analysed grafted CNT=corrected weight loss 150-650° C. (%)/(28*Functionality)

Where 28 is the Nitrogen molecular weight and functionality is the number of Si atom for each silane molecule. Functionality was ½ for sarcosine

Example 1 was made using respectively silane 1 and CNT Comparative example C1 was made using molecule, 5 equivalent of p-H2CO and CNT. It was used as a reference for system grafting through 1,3-dipolar cycloaddition as azaraidine compound were known to act.

Comparative example C2 was pure CNT reference product
Comparative example C3 was CNT following all treatment procedure to understand impact of treatment procedure on CNT

TABLE 1

| | | | Treatment |
|---|---|---|---|
| Exam- | | Quantities of | procedure (hr/ |
| ple | Molecule(s) | material (g) | temperature) |
| 1 | 3-(propyltriethoxysilyl)-N- | CNT: 8.0 g | 6 hrs at 210° C. |
| | benzyl aziridine carboxylate | Silane: 8.49 g | |
| 2 | 3-(propyltriethoxysilyl)-N- | CNT: 8.0 g | 1 hrs at 210° C. |
| | benzyl aziridine carboxylate | Silane: 8.49 g | |
| 3 | 3-(propyltriethoxysilyl)-N- | CNT: 8.0 g | 2 hrs at 210° C. |
| | benzyl aziridine carboxylate | Silane: 8.49 g | |
| C1 | Sarcosine + p-H2CO | CNT: 8.1 | 2 hrs/210° C. |
| | | Sarcosine: 4.56 | |
| | | p-H2CO: 7.69 | |

TABLE 2

| | Organic | Residue at | | Product mol reacted |
|---|---|---|---|---|
| | specied loss | 1000° C. | Corrected | on CNT surface for |
| exam- | 150-650° C. | (weight %) | residue | 100 g of analysed |
| ple | (weight %) | in air | (weight %) | grafted CNT |
| 1 | 25.8 | 18.62 | 8.91 | 0.1485 |
| 2 | 28.86 | 17.03 | 7.32 | 0.122 |
| 3 | 27.85 | 16.98 | 7.27 | 0.121 |
| C1 | 4.0 | 8.7 | 1.68 | 0.12 |
| C2 | 2.32 | 9.71 | — | — |
| C3 | 2.13 | 9.06 | — | — |

Example 1 showed the ability of silane 1 to graft to CNT to an acceptable level as compared to comparative example C1.

Example 1 to 3 showed an increase level of grafted silane on the CNT. This evolution tends to say that the surface of the CNT is not saturated and that more silane can be grafted to the surface. To increase silane grafting it can be advantageous to increase treatment time or temperature of treatment to increase grafted density.

DSC measurement on sample previous to heat treatment did also confirm the presence of a strong exotherm using silane 1 at a temperature of 210° C. (using 10° C./min ramp). This exotherm was the sign of the 1,3-dipolar cycloaddition of the silane on the CNT.

Example 1 showed the ability of aziridine function to graft to CNT. The presence of the benzyl site on the nitrogen may however limit grafted ability due to electronic influence or steric hindrance on the aziridine cycle. Using 3-(propyltriethoxysilyl)-N-propyltriethoxysilyl aziridine carboxylate will show the same benefit with the advantage of the use of a bis-silane structure that can modify the interphase structure and provide better flexibility to limit crack propagation in thermoset or thermoplastic resins or increase tear strength in rubber applications

Those silanes will be used potentially together with a second silane to allow introduction of a new chemistry on the surface of the carbon filler. Those new functionality will render carbon filler more reactive to any polymeric matrix to allow coupling between matrix and filler to improve mechanical performances. Example of silane will be:
Aminopropyltriethoxysilane, glycydoxy-propyl-trimethoxysilane for epoxy matrixes for printed circuit boards or wind core blade laminates or Maleic anhydride-g-Polypropylene for automotive application,
Methacryloxypropyl or bis-(trethoxysilylpropyl)-fumarate for polyester resins for printed circuit boards or wind core blade laminates,
Vinyl silane for polyester resins,
Bis-(triethoxysilylpropyl)-fumarate or mercaptopropyltriethoxysilane or bis-(triethoxysilylpropyl)-tetrasulfane or disulfane for diene elastomers and tyre or engineered rubber goods application,
Sorbyloxypropyltrimethoxysilane for neat Polypropylene.
Any silane known in the art to graft or react with any type of polymeric matrix can be used.

1. A process for modifying the surface of a carbon based filler by treatment with a hydrolysable silane, characterised in that the hydrolysable silane is a silane of the formula G-OC(O)-(Az)-J wherein G and J each represent a hydrocarbyl or substituted hydrocarbyl group having 1 to 40 carbon atoms, at least one of G and J being a group of the formula RₐR″₃₋ₐSi-A (herein called “silane group”) in which R represents a hydrolysable group; R″ represents a hydrocarbyl group having 1 to 8 carbon atoms; a has a value in the range 1 to 3 inclusive; Az represents an aziridine ring bonded to the group J through its nitrogen atom; and A represents a divalent organic spacer linkage having at least one carbon atom provided that when in J, A is a propyl group then G has at least 3 carbon atoms.

2. A process according to claim 1, characterised in that the hydrolysable silane has the formula RₐR″₃₋ₐSi-A-OC(O)-(Az)-J wherein R, R″, A, a and Az are defined as in claim 1 and J represents a hydrocarbyl or substituted hydrocarbyl group having 1 to 40 carbon atoms.

3. A process according to claim 1, characterised in that the hydrolysable silane has the formula G-OC(O)-(Az)-A-Si—Rₐ—R″₃₋ₐ wherein R, R″, A, a and Az are defined as in claim 1 and G represents a hydrocarbyl or substituted hydrocarbyl group having a total of 3 to 40 carbon atoms.

4. A process according to claim 3, characterised in that the group G of the hydrolysable silane represents a substituted hydrocarbyl group which is the residue of a polyol having 2 to 6 alcohol groups, the group G being bonded to 1 to 6 groups of the formula —OC(O)-(Az)-A′-Si—RₐR″₃₋ₐ wherein R, R″, A, a and Az are defined as in claim 1.

5. A process according to claim 1, wherein both J and G are silane groups.

6. A process according to claim 1, characterised in that each group R is an alkoxy group having 1 to 4 carbon atoms, preferably an ethoxy group.

7. A process according to claim 1, characterised in that a=3.

8. A process according to claim 1, wherein the carbon based filler comprises carbon fibres.

9. A process according to claim 1, wherein the carbon based filler is carbon black.

10. A process according to claim 1, wherein the carbon based filler is selected from carbon nanotubes, graphene and expandable graphene.

11. A carbon based filler modified by treatment with a hydrolysable silane according to claim 1.

12. A filled polymer composition comprising an organosilicon polymer and a modified carbon based filler as defined in claim 11.

13. A filled polymer composition comprising a an organic polymer, a crosslinking agent containing organosilicon groups and a modified carbon based filler as defined in claim 11.

14. A filled polymer composition comprising a polymer matrix a modified carbon based filler as defined in claim 11, and any other type of filler or fibre.

15. (canceled)
